(19) United States
(12) Patent Application Publication
(10) Pub. No.: US 2014/0229351 A1
(43) Pub. Date: Aug. 14, 2014

(54) METHOD AND APPARATUS FOR LISTING AND TRADING A FUTURES CONTRACT WITH VARIABLE DELIVERY AND/OR EXPIRY DATES

(71) Applicant: BGC Partners, Inc., New York, NY (US)

(72) Inventors: Howard W. Lutnick, New York, NY (US); Michael Sweeting, Aldershot (GB); Joseph Noviello, New York, NY (US)

(21) Appl. No.: 13/766,632

(22) Filed: Feb. 13, 2013

(51) Int. Cl. G06Q 40/04

(52) U.S. Cl. CPC G06Q 40/04
USPC 705/37

(57) ABSTRACT

According to various embodiments, a futures contract may be listed on a futures trading Exchange. The futures contract may physically settle at a selectable or variable delivery date into an underlying derivative trade. The underlying derivative trade may be cleared by a Clearing House so that the physical settlement requires that the holder of a position in the futures contract upon expiration or delivery takes a specified side of the underlying derivative trade against another party such as the Clearing House.

### FIELD OF THE INVENTION

The present invention relates to trading products such as financial derivatives and computer systems and computer-implemented methods for facilitating trading of such products.

### BACKGROUND

Financial markets generally afford the opportunity for investors to purchase an asset in order to achieve some degree of profitability. Investment vehicles such as stocks, trusts, mutual funds, pension funds, money markets, and bonds represent example investment instruments that offer investors a choice for allocating capital. One investment vehicle that has enjoyed sustained success, increased notoriety, and the prospect for optimal yields is the futures contract.

A futures contract is an agreement to buy or to sell a specific quantity of some asset at some time in the future, whereby the price of the asset is agreed upon at the time the agreement is made. Any asset whose future price is uncertain is a candidate for a futures contract. Example assets include government issued bonds, corn, wheat, cotton, coffee, cocoa, pork bellies, gasoline, heating oil, lumber, live cattle, gold, silver, yen, pounds, pesos, marks, T-bills, Eurodollar CDs, or any other suitable asset or commodity.

In any given marketplace, there are generally enough consumers and producers who want to diminish the price uncertainty (hedgers) and enough other traders willing to take on that risk (speculators) in order for the futures contract to be successful, i.e., worthwhile for the contract to be listed on a futures Exchange.

Unlike a stock, which represents equity in a company and an asset that can be held for a long time, (if not indefinitely), a futures contract generally has a finite life. A futures contract can be used for hedging commodity price-fluctuation risks or for taking advantage of price movements, rather than for the buying or selling of the actual cash commodity. The word “contract” is used to describe a futures arrangement because a futures contract requires delivery of the commodity at a stated time in the future unless the contract is liquidated before it expires.

A buyer of a futures contract (the party having a long position) can agree on a fixed purchase price to buy the underlying commodity (wheat, gold or T-bills, for example) from the seller at the expiration of the contract. The seller of a futures contract (the party having a short position) can agree to sell the underlying commodity to the buyer at expiration at the fixed sales price. As time passes, the contract's value changes relative to the fixed price at which the trade was initiated. This creates profits or losses for the trader. In most cases, delivery associated with the futures contract does not take place. Instead, both the buyer and the seller, acting independently of each other, usually liquidate their long and short positions before the contract expires.

The endeavor of futures contracts is generally a zero-sum equation. Futures contracts are marked to market daily. A futures contract generally has no value when purchased or sold initially. During a given trading day, as the price fluctuates, the futures contract will take on value depending on whether the market price rises or falls and whether the trader was long (bought the contract) or short (sold the contract). Whatever gain or loss that was achieved during the day is added to or subtracted from the trader's account at the end of each trading day.

Futures trading is highly leveraged with margins only a fraction of contract nominal values, creating a highly advantageous way of gaining exposure to the commodity, financial instrument or derivative underlying the futures contract.

There are a wide variety of financial derivatives currently available in the market. In general, a financial derivative is a contract or financial product whose economic value can be derived from one or more other financial products.

One type of derivative is a swap, and one type of swap is referred to as an “interest rate swap”. In one variety of interest rate swaps, one counterparty agrees to make fixed payments of interest to the other counterparty over a period of time on a notional amount of principal. The second counterparty agrees to make payments to the first counterparty that fluctuate over the period of time in accordance with fluctuations in a “floating” interest rate (such as the LIBOR (London Interbank Offered Rate) three month rate, TIBOR (Tokyo Interbank Offered Rate) or OIS (Overnight Index Swap rate). This type of interest rate swap is referred to as a fixed/floating interest rate swap. The period of time during which the swap is effective may be referred to as its “tenor”. Interest rate swaps and other swaps may also be employed as part of financial strategies that are much more complex than simple hedging or speculation. A financial futures contract can also be based upon another type of derivative, such as a swap.

### BRIEF SUMMARY OF THE INVENTION

Various embodiments of the present invention relate to methods and apparatus for managing and facilitating the configuration, creation, listing, and primary and secondary trading of trading products such as improved swap futures contracts.

Various embodiments are directed to a futures contract that can be converted into another type of derivative instrument, such as a swap contract, at a variable or selectable date or time. In some embodiments, the futures contract may specify that the date of delivery can be determined at a later date (e.g., after purchase, sale, and/or settlement of the futures contract). For example, the futures contract may specify that the delivery date may be selected by one or more parties from one or more of a range of dates (e.g., “any day between six and seven months after purchase of the futures contract”, or “any day between March 5-8 or April 2-5”); a variable date; a date that will be determined or triggered based on one or more pre-defined or later-defined conditions (e.g., the last calendar or trading day before an event such as the day a payment is due or made in accordance with the futures contract); a date that may be later specified by a third party; a date that may be later specified by the buyer, seller, or issuer of the futures contract; or another date.

In various embodiments, systems, methods, and computer-readable media are provided to list, trade, cause to be traded or listed, configure, or cause to be configured a futures contract. The futures contract may comprise terms that facilitate delivery of a specified swap to a Clearing House according to a delivery time specified in the futures contract. In some embodiments, the delivery time may comprise a date on or within a specified date range. In some embodiments, the delivery time may comprise a date prior to a specified deadline date. In some embodiments, a family of possible swap futures may be listed, and an individual futures contract may be able to be immediately listed based on an underlying swap customized for a particular start date, tenor, end date or payment dates. In some embodiments, the individual futures contract may be created in response to a request from a user for a futures contract and/or swap contract that matches various user-defined criteria.

In some embodiments, the specified swap contract may be delivered on a day determined after settlement of the futures contract.

In some embodiments, the specified swap contract may be delivered on a day determined by a purchaser of the futures contract.

In some embodiments, the specified swap contract may be delivered on a day determined by a party other than a holder of the futures contract.

In some embodiments, the specified swap contract may be delivered on a day determined by a Clearing House according to an algorithm provided by an Exchange.

In some embodiments, the futures contract may expire on an expiration date that is on or within a date range specified in the futures contract.

In some embodiments, the futures contract may expire on an expiration date that is prior to a deadline date specified in the futures contract.

In some embodiments, the futures contract may expire on a day determined after settlement of the futures contract.

In some embodiments, the futures contract may expire on a day selected by a purchaser or a seller of the futures contract.

In some embodiments, the futures contract may expire on a day selected by a party other than a holder of the futures contract.

In some embodiments, the terms included in the futures contract specify that the futures contract will expire after trading then upon the occurrence of zero open interest.

In some embodiments, the futures contract may expire upon the occurrence of zero open interest.

In some embodiments, an occurrence of zero open interest with respect to the futures contract may be determined. Based on that determination, the futures contract may expire or be caused to expire.

In some embodiments, the futures contract may be delisted upon the occurrence of zero open interest. In some embodiments, an occurrence of zero open interest with respect to the futures contract may be determined. Based on the determination, the futures contract may be delisted or be caused to be delisted. In some embodiments, the terms included in the futures contract specify that the futures contract will be delisted upon the occurrence of zero open interest.

In some embodiments, the futures contract may specify a variable expiry upon delivery of an underlying Swap into the specified futures contract. The variable contract expiry upon delivery of the specified swap contract may trigger or prompt de-listing of said futures contract.

It will be appreciated that the swap contract may comprise any type of swap contract, such as an interest rate swap, a yield curve swap, a credit default swap, a credit default index swap, a cross currency swap, a constant maturity swap, a variance swap, a volatility swap, a basis swap, an asset swap, a commodity swap, an equity swap and/or a dividend swap.

In another exemplary method, a futures contract may be traded via at least one processor. The futures contract may include terms that facilitate delivery of a specified swap to a Clearing House according to a delivery time consisting of one of: a date on or within a specified date range, and a date prior to a specified deadline date. The futures contract may expire upon the occurrence of zero open interest.

In another exemplary embodiment, a futures contract may be listed via a computer. The futures contract may include terms that facilitate variable contract expiry upon delivery of a specified swap to a Clearing House according to a delivery time consisting of one: a date on or within a specified date range, and a date prior to a specified deadline date. The futures contract may be delisted upon an occurrence of zero open interest.

In another exemplary embodiment, at least one processor may receive from a Trader a request for a futures contract to be listed on an Exchange. Responsive to the request, the at least one processor may cause a futures contract to be listed on the Exchange. The listed futures contract may include terms that facilitate delivery of a swap to a Clearing House according to a delivery time specified in the futures contract. The delivery time may comprise one of: a date on or within a specified date range and a date prior to a specified deadline date. In some embodiments, the act of receiving the request from the Trader may comprise receiving date criteria, in which the delivery time satisfies the date criteria.

In another exemplary embodiment, at least one processor may receive from a user one or more specifications relating to a futures contract. Responsive to receiving the one or more specifications, the at least one processor may cause to be output a listing of at least one futures contract that satisfies the one or more specifications. The at least one processor may receive from a user a request to purchase or sell a first of the at least one futures contract that satisfies the one or more specifications. The first futures contract may include terms that facilitate delivery of a specified swap to a Clearing House according to a delivery time specified in the first futures contract. The delivery time may comprise one of: a date on or within a specified date range and a date prior to a specified deadline date.

### BRIEF DESCRIPTION OF THE FIGURES

To provide a more complete understanding of the present invention and features and advantages thereof, reference is made to the following description, taken in conjunction with the accompanying figures, wherein like reference numerals represent like parts, in which:

FIG. 1 is a simplified block diagram of an investment system for providing a futures contract in a financial market environment in accordance with an embodiment of the present invention;

FIG. 2 is a simplified block diagram of an example futures contract in accordance with an embodiment of the present invention; and

FIG. 3 is a flowchart illustrating a series of example steps associated with a method for providing a futures contract in a financial market environment.

### DETAILED DESCRIPTION

The following sections I-XI provide a guide to interpreting the present application.

### I. Terms

The term “product” means any machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget).

An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed, and does not imply that numerical methods must be used, and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. Disclosed Examples and Terminology are not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. §1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an Exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### DETAILED DESCRIPTION OF EXEMPLARY EMBODIMENTS

In some embodiments, futures contracts according to the features described herein may be created and immediately traded on a Designated Contract Market or Futures Exchange. In some embodiments, the futures contracts may be futures contracts on an underlying swap contract, though other underlying contracts may be considered. In some embodiments, the futures contract created may belong to a series of contracts authorized by a regulatory body for trading. In some embodiments, the delivery date of the futures contract may be specified by one or more date ranges or other criteria as opposed to a single predetermined date known at the time of initial issuance of the futures contract.

Various embodiments comprise a method, a system, an apparatus, and a medium storing processor-executable process steps to list a futures contract. In one embodiment, the futures contract provides for physical delivery of an underlying Over the Counter (OTC) cleared Interest Rate Swap at a variable delivery date whereupon the futures contract itself may be subject to a variable expiry date thereafter.

In another aspect, embodiments of the present invention concern a method, a system, an apparatus, and a medium storing processor-executable process steps to provide a computer implemented method of trading a futures contract of the type described in the preceding paragraph and elsewhere herein.

In yet another aspect, embodiments of the present invention concern a method, a system, an apparatus, and a medium storing processor-executable process steps to input a buy and/or sell order in a futures contract of the type described above (and elsewhere herein), and to receive one or more electronic signals, each respectively representing an order to buy and/or an order to sell the futures contract. Said order may be a traditional Limit order, Market order, One-Cancels-Other order, Fill or Kill order or any other type of order type provided by the system, apparatus and medium storing processor-executable process.

In any one or more of the above aspects, the specified swap may be against a specified counterparty, or may be novated to a central Counterparty such as a Clearing House. The specified swap may be a fixed/floating interest rate swap, a floating/floating interest rate basis swap, a cross currency foreign Exchange swap, a cross currency interest rate swap, a constant maturity swap, an equity swap, a dividend swap, a commodity swap, a credit default index swap or a single-name credit default swap. The specified swap may be of the same currency for each side or may also be of different currencies on each side.

In alternative embodiments, the specified swap may be of a type that is different from the types of swaps in the previous paragraph.

In some aspects, it may be particularly advantageous that the futures contract physically settles into a swap that is cleared via a Clearing House. By providing such a futures contract, and providing for cleared swaps into which the futures contract physically settles prior to or upon expiration, dealers may be able to make markets using better value judgments in such futures contracts since they will not face large changes in exposure upon such delivery or expiration of the futures contract. The Clearing House for the futures contract may be the same entity as the Clearing House for the cleared swap underlying the futures contract or it may be a different Clearing House entity. Further, since there may be an underlying over-the-counter market in the cleared swaps, the value of the futures contract on expiration may be determined by the underlying swaps market, thereby supporting the integrity of the futures contract.

Moreover, the physical settlement of the futures contract into a cleared swap may promote a favorable regulatory treatment for the futures contract.

Further, the initial and mark-to-market variation margin of the futures contract may promote a favorable margin treatment for the futures contract over the cleared swap underlying the contract.

With these and other advantages and features of the invention that will become hereinafter apparent, the invention may be more clearly understood by reference to the following detailed description of the invention, the appended claims, and the drawings attached hereto.

Trading Units.

In some embodiments, the trading unit may comprise one or more standard trading quantity amounts of one or more currencies, such as USD, EUR or GBP 1,000,000 or 100,000,000 JPY notional face value Interest Rate Swap (“IRS”).

In some embodiments, the underlying Swap contract may comprise Swap tenors of 1 Month, 2 Months, 3 Months, 1 Year, 2 Years, 3 Years, 10 Years, 30 Years, or any other N Month, N Year or NNYears, e.g., using over the counter (“OTC”) standard Swap conventions. In some embodiments the underlying Swap contract may comprise of a tenor derived from fixed start and end dates.

Some examples include:

EUR Fixed Annual Bond Basis vs. Floating 6 M EURibor; EUR Fixed Annual Bond Basis vs. Floating 3 M Euribor, EUR Floating 3 M Euribor vs. Floating 6 M Euribor; EUR Fixed Annual Bond Basis vs. Floating EONIA (European Overnight Index Average)

USD Fixed Semi-Annual Bond Basis, Floating 3 M USD Libor; USD Fixed Annual Money basis vs. Floating 3 M USD Libor, USD Floating 6 M Libor vs. Floating 3 M USD Libor; US Fixed Annual Money Basis vs. Floating USD OIS (Overnight Index Average)

GBP Fixed Semi-Annual Money Basis vs. Floating 6 M GBP Libor; GBP Annual Money Basis vs. Floating 3 M GBP Libor; Floating 6 M GBP Libor vs. Floating 3 M GBP Libor; GBP Fixed Annual Money Basis vs. Floating SONIA (Sterling Overnight Index Average)

JPY Fixed Semi-Annual Bond Basis vs. Floating 6 M JPY Libor; JPY Fixed Annual Bond Basis vs. 3 M JPY Libor; Floating JPY 3 M Libor vs Floating JPY 3 M Tibor; JPY Fixed Annual Money Basis vs. Floating TONAR (Tokyo Overnight Average Rate)

In some embodiments, the underlying Swap contract may comprise Interest Rate Swap (IRS) tenors that are forward starting on dates of 2 days, 3 days, 4 days, any other number of days, 1 Month, 2 Months, 3.5 months, any other number of months or fractional months, 1 Year, 2 Years, 3 years, 5 years, 10 Years, 15.5 years, any other number of years including fractional years, or any other date. In some embodiments, the underlying Swap contract may comprise tenors that are forward starting on specific dates to then end on specific dates.

Contract Expires.

In some embodiments, contracts may comprise expiry dates of 2 days, 3 days, 4 days, any other number of days, 1 Month, 2 Months, 3.5 months, any other number of months or fractional months, 1 Year, 2 Years, 3 years, 5 years, 10 Years, 15.5 years, any other number of years including fractional years, or any other date. In some embodiments, a family of possible swap futures contracts may be listed and e.g., at a user interface, underlying swap terms may be inferred from start dates and tenors and/or termination dates. In some embodiments, a family of possible swap futures may be listed (e.g., and displayed at a user interface) and the prospective purchaser or seller of such contract may be able to immediately list a futures contract based on an underlying swap customized for a particular start date, tenor, end date and/or payment dates.

In some embodiments, the contract expiry date may be a predetermined date (e.g., Aug. 1, 2015). In other embodiments, the contract expiry may be selectable, determined at a future date from a range, or otherwise variable, e.g., as described herein for a variable delivery date. For example, the features described herein for delivery dates—including the types and conditions described below and the ability to view and configure such dates—may also apply to contract expiry dates. It should be appreciated that a futures contract may comprise a fixed expiry date and fixed delivery date, a fixed expiry date and a variable delivery date, a variable expiry date and a fixed delivery date, and/or a variable expiry date and a variable delivery date.

Quote Convention.

In some embodiment, prices may be quoted in % Interest Rate Coupon such that a buyer of the futures contract equates to the payer of the underlying swap and the seller of the contract equates to the receiver of the underlying swap. In some embodiment, prices may be quoted in percentage of face value of a Swap such that a buyer of the futures contract equates to the perceiver of the underlying swap and the seller of the contract equates to the payer of the underlying swap. Other quote conventions may be used.

Contract Fixed Rate Minimum Price Increment.

Any increment may be used. In a cash market, for example, the fixed rate minimum price increment may comprise:

USD 0.0005%

EUR 0.00025%

GBP 0.0005%

JPY 0.0005%

Other percentages may be used for these and other currencies.

Variation Margin Calculation.

In some embodiments, Variation Margin may be calculated by ascertaining the valuation difference of the contract versus the daily closing price. The valuation may use the NPV (net present value) of the IRS fixed-rate payments minus the NPV of IRS floating-rate payments, using OIS/EONIA/SONIA/TONAR discounting of all fixed rate future payments minus all Libor, Tibor or Euribor forecast floating rate payments, inferred by the closing term interest rate structure from the mid-market Interest Rate Swap curve on each margining day, as published by a Data provider such as BGC Market Data for example. In such an example, calculated variation margin could then be either a) subject to Price Alignment Interest (PAI—an interest rate assigned to margin payments), or b) reduced by an amount equivalent to the overnight rate applied to the variation margin (e.g., to equate to the same type of Interest Rate Swaps collateral payment treatment used in cleared Swaps), according to some embodiments. In some embodiments, the system may value a futures contract as a forward starting swap and determine how many basis points profit or loss the Customer's positions show on the day and pay or charge margin as the Forward PV01 (present value of a Basis Point) of the swap multiplied by the Basis points profit or loss of each Swap using the daily closing price of that futures contract. In some embodiments where a closing price of a futures contract is not immediately apparent, the futures Exchange may calculate a theoretical price for each contract from discount Factor curves derived from overnight index swap rates or any other applicable interest rate swap rates from the underlying Over-the-Counter Swap market. The system may then adjust for PAI to make variation margin payments equivalent to those charged on the underlying cleared OTC swaps.

First Trading Day.

In some embodiments, each futures contract's first trading day may be the demand day of listing. The details of the underlying swap start date, first payment date and end date as detailed above may be set at listing. Some contracts may be listed by the Exchange as regularly traded contracts, and some custom dated contracts may be listed by the Exchange upon participant demand, accommodating a more flexible structure to Futures contract listing and the ability for an eligible contract participant (“ECP”) (e.g., per Section 1a(18) of the Commodity Exchange Act) or a “Trader” (defined herein as any person granted trading privileges on an Exchange or Designated Contract Market), to list a futures contract with an underlying swap of Customized start dates, tenors, end dates or payment dates.

Expiry Day.

In some embodiments, the futures contract can expire on any date between trade date up to and including one day before the first payment date of the underlying Swap. A contract expiry may be also prompted by a notice of intention to deliver a Futures position into the underlying OTC cleared Swap. Where a contract delivery results in zero open interest for that futures contract, it may then expire or be de-listed by the Exchange.

Last Trading Day.

In some embodiments, trading in expiring futures terminates at 2 pm (Local Time of Contract) on Expiry day. Other times and dates can also be considered. Where a contract delivery results in zero open interest for that futures contract before expiry date, it may also be then prematurely expired and de-listed by the Exchange and may be advertised as such, so the expiry date of the contract is variable, in some embodiments.

Delivery Day.

In some embodiments, delivery day may comprise any day between trade date and one day before the first payment date of the underlying Swap. Delivery may be prompted by the Exchange during this window, or by notice of intention to deliver an underlying Swap into a Futures position by a Trader. Where a Trader prompts delivery, the Exchange may identify an opposing side of the open interest via an algorithm that may include pro-rata, size matching, Customer type matching or any other suitable algorithm to match opposing positions from the open interest in the Futures contract.

In some embodiments, a futures contract may not have a specific pre-defined delivery date. In some embodiments, the delivery date and delivery date selection criteria may comprise any one or more of the following:

(i) A date that is selectable at a future time by one or more parties, e.g., according to one or more ranges or parameters. Selecting parties may comprise a Clearing House, an Exchange, and/or a party that is long or short in the futures contract or the underlying swap or other instrument. It should be appreciated that more than one party, such as one or more long parties and one or more short parties, may have control over delivery date selection for a given futures contract. In some embodiments, multiple parties will have control over multiple futures contract delivery dates. For example, all 200 parties that are long in one type of futures contract may have the right to trigger delivery; when a long party triggers delivery for a specific date, an algorithm may be used to select a party or a futures contract from among 150 short parties who must satisfy the obligation to deliver on the specific date. Notably, in this example, the selecting party does not know in advance which party's delivery obligation will be triggered.

(ii) A plurality of dates, such as one or more dates and/or date ranges like Aug. 20-30, 2018.

(iii) A date defining a final deadline for delivery, such as a date when a first payment on an underlying swap becomes due. In some embodiments, the final deadline for delivery may comprise one day (e.g., calendar or trading day) prior to the first date of payment.

(iv) A date determined by an algorithm, e.g., a date determined by a Clearing House according to an algorithm provided by an Exchange. For example, if a party (e.g., a party who is short) elects delivery on Jun. 15, 2013 and there are thirty different parties (e.g., parties who are long) who are eligible for delivery under the terms of their contracts, then the Clearing House may apply an algorithm to determine that the 22^{nd} of these thirty parties must satisfy the delivery obligation on Jun. 15, 2013. Any algorithm known in the art may be used to select from among a plurality of eligible futures contracts for imposing a specific delivery obligation, e.g., in response to a request for delivery on a specified day, date range, or other delivery date criterion.

(v) A date triggered by one or more default or configurable parameters or conditions. For example, a futures contract may specify that the date of delivery will be the earlier of (1) two trading days after the Dow Jones Industrial Average first exceeds 16,000, (2) a date between Oct. 1-31, 2014 designated by party ABC after Sep. 15, 2014, and (3) Oct. 20, 2014.

(vi) A date defined by one or more of the above criteria, such as a date that is the earlier or later of a date satisfying condition (ii) and a date satisfying condition (iv).

For example, in some embodiments, the futures contract may specify that one or more parties, such as a holder of the futures contract, an Exchange or Designated Contract Market (DCM) and/or a central counterparty such as an Exchange or Clearing House, may select a delivery date. The delivery date may be selected from among a plurality of possible dates, such as any day between Jun. 1, 2015 and Jul. 1, 2015, or any date prior to a deadline of Aug. 15, 2015.

In some embodiments, the actual delivery date may be a date selected by the relevant Exchange, DCM or Clearing House (e.g., by applying an algorithm provided by the relevant Exchange), or a date triggered or selected by a party with a long or short position in this futures contract or another related futures contract.

In some embodiments, criteria defining a delivery date may change over time for a given contract. For example, one set of delivery date parameters may apply for the first six months of the futures contract, and a different set of delivery date parameters may apply until expiration (e.g., during the last five days before a final delivery date deadline). For example, during the first six months, the delivery date may be freely selectable by the holder of the contract from within a specified date range, and during the last five days before the final deadline, the delivery date may only be selectable by the Clearing House (or other party) from among the last and second-to-last days of contract expiration.

In some embodiments, the delivery date may comprise a date determined before the listing or settlement date but that is not disclosed to a buyer or holder of the futures contract until a later date, e.g., a date after purchase and/or settlement but before delivery. For example, the futures contract may specify that the delivery date is pre-determined (e.g., and known to the Exchange or Clearing House or another party) but that it will not be disclosed to a purchaser or holder of the futures contract until a later time, such as one or more days before the delivery date. Information about the delivery date may be disclosed to one or more other parties, such as the Clearing House, Exchange, or another long or short party.

In some embodiments, a family of possible swap futures contracts may be listed, e.g., at a user interface, and underlying swap terms may be inferred from start dates of an underlying swap, termination dates of an underlying swap, payment dates of an underlying swap, or any combination thereof.

In some embodiments, the delivery dates may comprise a range of dates, e.g., any date from today to one day before the first cash payments of the underlying Swap would be due.

Information about delivery dates, including information about any specific dates, date ranges, final deadlines for expiry, and other information may be displayed or transmitted to users, such as potential purchasers and sellers of the particular futures contract.

Delivery Standard.

In some embodiments, delivery standards may use reference conventions.

For example, in some embodiments, a Standard Clearing House Interest rate Swap may be created and either:

(i) entered via a Swap Execution Facility (“SEF” as defined by the US Dodd-Frank act and regulated by the US Commodities and Futures Trading Commission) as an Exchange of Derivatives for Related Positions into the relevant Clearing House; and/or

(ii) entered directly into the Clearing House as a Swap borne from a futures contract delivery.

In some embodiments, a buyer of a futures contract may equate to a fixed rate payer of the underlying IRS. In some embodiments a seller of a futures contract may equate to a fixed rate payer of the underlying IRS.

In some embodiments, a seller a futures contract may equate to a fixed rate receiver of the underlying IRS. In some embodiments a buyer of a futures contract may equate to a fixed rate receiver of the underlying IRS.

In some embodiments, Reference Tenors may comprise any IRS Instrument tenor.

In some embodiments, a notional amount may comprise 1,000,000 (USD, EUR or GBP) or 100,000,000 (JPY) Notional per futures contract.

In some embodiments, the IRS Effective Date may comprise the Futures Expiry day.

In some embodiments, a Fixed Rate of the underlying Swap at futures contract delivery may be established by an Exchange platform or DCM such as ELX, as the “Exchange Delivery Settlement Price” (EDSP) and margin payments effected up to that point of delivery. The EDSP may be the final contract valuation at delivery and the Swap price subsequently entered into the Clearing House at futures delivery. Where a futures contract exhibits low liquidity at expiry, the Exchange may perform a theoretical valuation of the Futures contract using OTC Swap mid-market prices at the futures expiry time to publish an EDSP, e.g., if an EDSP cannot be calculated.

Delivery Method.

In some embodiments, an Exchange platform or DCM (such as ELX) or a swap execution facility such as BGC's SEF may create a market standard Swap at the EDSP closing price and time for use in the delivery mechanism. Futures initial margin and final variation margin may be calculated and applied to a futures delivery invoice (e.g., without PAI adjustment) and upon delivery into the Clearing House, said Clearing House may then portfolio margin as a new cleared “physical” Swap. In some embodiments, the futures contract may be margined as a forward starting swap using Forward Present Value of a Basis Point (PV01) of the swap multiplied by the Basis points profit or loss the contract shows, daily until either Delivery or one day before the underlying Swap's first payment date whereupon, in some embodiments, on the last possible delivery day the system, Exchange, DCM, Clearing House or other party may enact a final margin calculation and/or may create the Swap for OTC clearing at End-of-Day market price levels.

Delivery Eligibility.

In some embodiments, delivery may be limited to Traders and/or eligible contract participants (“ECPs”), e.g., per Section 1a(18) of the Commodity Exchange Act. In some embodiments, delivery may be limited to direct clearing members or third party clearing members registered with the Clearing House for the underlying Swap.

Trading Hours.

In some embodiments, the futures contracts may be issued and traded, during traditional trading hours for the underlying swap and/or during any time when a major trading Exchange or DCM is open for trading. Trading hours may be different for different types of contracts, currencies, or other financial characteristics or markets. For example, trading hours may comprise:

USD 7:00 pm to 5:30 pm EST, Sun-Fri.

EUR 0:00 am to 5:30 pm London time, Mon-Fri.

GBP 8:00 am to 5:30 pm London time, Mon-Fri.

JPY 8:00 am to 11:30 pm Tokyo time, Mon-Fri

In general, and for the purposes of introducing concepts of embodiments of the present invention, a futures contract is traded and provides for physical settlement, upon variable contract expiration, into a swap. To accomplish the physical settlement, the holder of a position in the futures contract may be required to take a specified side of the underlying swap with a Clearing House as the counterparty upon delivery day to expire their futures position and replace it with an equivalent cleared OTC Swap position. For example, upon delivery the holder of a long position in the futures contract may be required on expiration to receive the fixed side of the swap against the Clearing House, while the holder of a short position in the futures contract may be required on expiration to receive the floating side of the swap against the Clearing House. In another embodiment, upon delivery the holder of a short position in the futures contract may be required on expiration to receive the fixed side of the swap against the Clearing House, while the holder of a long position in the futures contract may be required on expiration to receive the floating side of the swap against the Clearing House.

In some embodiments, a user may search for futures contracts having criteria specified by the user. For example, the user may run search queries to find futures contracts having contract terms that satisfy user-specified parameters, e.g., terms that have contract expiration, listing date, notional value, delivery date, etc., of a user-specified date, value, or range. In another embodiment, the user may run search queries to find futures contracts having underlying swap terms that satisfy user-specified parameters, e.g., terms that have a particular swap type, tenor, start date, end date and/or payment dates, etc., of a user-specified date, value, and/or range. The system may output one or more futures contracts that satisfy the user-specified criteria. The user may select one or more of the futures contracts to purchase or sell. In some embodiments, a user may request that the system provide a futures contract having terms designated by the user, e.g., if such futures contract does not already exist.

Underlier Swaps in Other Embodiments.

In other embodiments, the swap that underlies the futures contract may be a total return swap, an equity swap, a commodity swap, a currency swap, or a yield curve swap. In still other embodiments, the underlying swap may be a Commercial or Residential Real Estate Index Swap i.e., a swap in which one side is obligated to make payments based on an index of commercial property or housing prices. In further embodiments, the underlying swap may be an “inflation swap”, i.e., a swap in which one side is obligated to make payments based on an index of prices for consumer or producer goods and/or services. In still further embodiments, the underlying swap may be a constant maturity swap, a variance swap or a volatility swap.

Other types of swaps that are not explicitly mentioned herein may also underlie a futures contract provided in accordance with the invention.

In some embodiments, the Exchange systems may publish an expiry and/or delivery date and/or information about a delivery and/or expiry date, such as a delivery date range or deadline. In some embodiments, a user interface may display parameter data to users, including information about delivery and/or expiry dates, such as a delivery date range or deadline.

In some embodiments, a Trader or ECP may enter the parameter data for the Futures contract they wish to trade and the Exchange seek to list said contract as part of the agreed family of contract specifications as noted above. The parameter data for the contract may include a designation of the particular swap underlying the contract, parameters including but not limited to fixed rate type, floating rate type, day count convention, currency, compounding, index, credit, reference obligation, fixed coupon, swap documentation, payment dates, variance, volatility, total investment return, yield, delivery date range, Clearing House, regulatory jurisdiction,

It will be appreciated that holders of open positions in futures contracts described herein may liquidate their positions prior to expiration of the futures contract to either avoid being obligated to enter into the underlying swap upon expiration of the futures contract. It will also however be appreciated that holders of open positions in futures contracts described herein may elect to close their open futures position by delivering the contract standard swap into the futures position hence expiring their futures obligation and delivering a swap position for OTC Clearing House novation.

In at least some cases, the swaps that underlie the physically-settled swap futures may be defined in accordance with a “Master Agreement” maintained by the International Swaps and Derivatives Association (ISDA) or a particular type of swap standard such as the Standard North American Corporate standard used for single name credit default swaps.

The Figures show various exemplary features and embodiments.

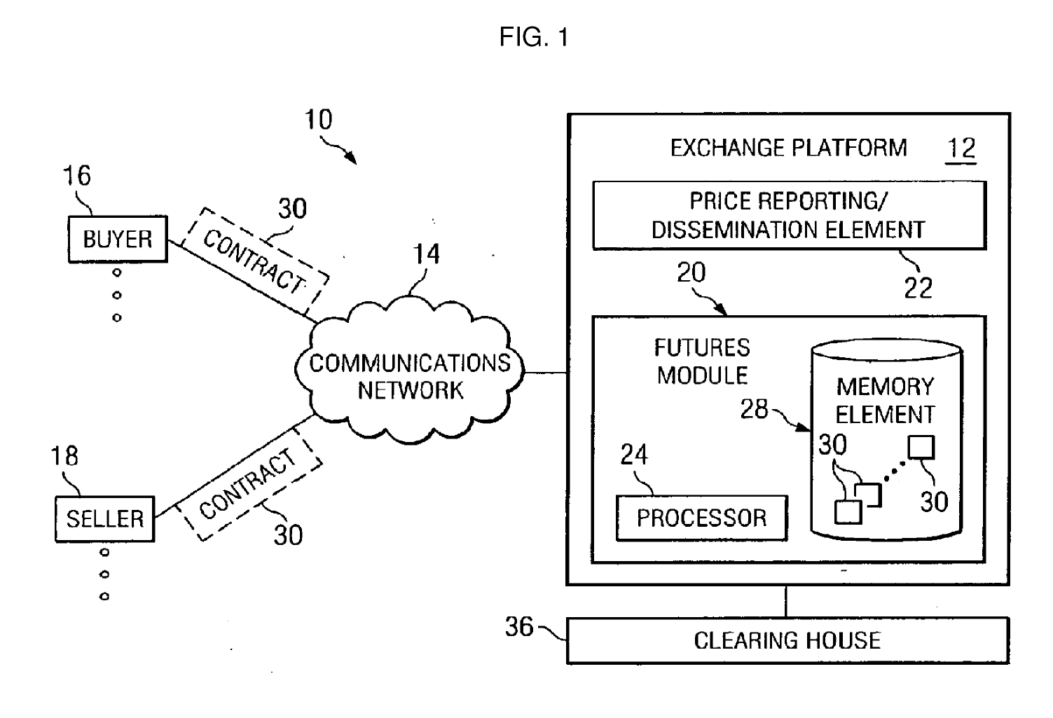

FIG. 1 is a simplified block diagram of an exemplary system 10 for providing futures contracts in a financial market environment. System 10 comprises an Exchange platform 12, a communications network 14, a buyer 16, and a seller 18. Exchange platform 12 may include a futures module 20 and a price reporting/dissemination element 22. Futures module 20 may include a processor 24 and a memory element 28, which may store one or more futures contracts 30. Exchange platform 12 may be coupled to a Clearing House 36.

System 10 may offer futures contract 30 in any suitable financial market place, whereby futures contract 30 provides for a variable delivery and/or variable expiry instrument. In some embodiments, the underlying swap of futures contract 30 may be of any of multiple swap types, and may include a wide array of investment opportunities as more fully detailed herein.

Exchange platform 12 may comprise a trading architecture that facilitates the purchase and sale of one or more futures contracts 30. Exchange platform 12 may be operable to receive and to process requests associated with transactions relating to futures contract 30. Exchange platform 12 may be a computer, a server, a management center, a single workstation, or a headquartering office for any person, business, or entity that seeks to manage the trading of futures contract 30. Accordingly, Exchange platform 12 may include any suitable hardware, software, personnel, devices, components, elements, or objects that may be utilized or implemented to achieve the operations and functions of an administrative body or a supervising entity that manages or administers a trading environment.

Exchange platform 12 may be owned and operated by any suitable entity having the authority to operate in the distribution of futures contracts. For example, Exchange platform may be a recognized futures Exchange, such as the ELX Financial Futures Exchange. A connection may be present between Exchange platform 12 and any other Swap Execution Facility (SEF) or futures Exchange (e.g. the Chicago Mercantile Exchange (CME)), whereby information associated with any transaction that is proposed by buyer 16 or seller 18 is relayed to an appropriate Exchange to consummate the transaction. Thus, Exchange platform 12 may operate as a proxy between buyer 16/seller 18 and a corresponding SEF or Exchange that can record and confirm a tendered purchase or sale of futures contract 30. Alternatively and where authorized, Exchange platform 12 may perform such trade execution functions independently. Where suitable, a connection may be present between Exchange platform 12 and any other entity, where authorized, that can record and confirm a tendered purchase or sale of futures contract 30 in at least a block trade size, e.g., as agreed by Exchange platform 12. Exchange platform 12 may also deliver real-time financial data to buyer 16 or seller 18 in order to provide pertinent financial information to be used to make decisions as to whether to purchase or to sell futures contract 30. This relay of financial information may be performed via price reporting/dissemination element 22 or any other suitable element. Data, such as pricing information, underlying swap data, historical quotes, or moving averages, for example, may be provided to buyer 16 and seller 18. Other financial data may also be readily delivered and based on particular needs. In order to deliver information that is accurate and timely, price reporting/dissemination element 22 may be coupled to a corresponding futures Exchange or DCM communications link that carries such financial data. Alternatively, price reporting/dissemination element 22 may gather such critical information from any appropriate location (e.g. a server operable to deliver real-time information to investors) such that the desired financial data is delivered to buyer 16 or seller 18.

Communications network 14 may comprise a communicative platform operable to Exchange data or information between buyer 16/seller 18 and Exchange platform 12. In some embodiments, communications network 14 represents an Internet architecture in a particular embodiment of the present invention, which provides buyer 16 or seller 18 with the ability to electronically execute trades or initiate transactions to be delivered to an authorized Exchange trading floor. Alternatively, communications network 14 could be a plain old telephone system (POTS), which buyer 16 or seller 18 could use to perform the same operations or functions. Such transactions may be assisted by a broker associated with Exchange platform 12 or manually keyed into a telephone or other suitable electronic equipment in order to request that a transaction be executed. In other embodiments, communications system 14 could be any packet data network (PDN) offering a communications interface or Exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

Buyer 16 and seller 18 may comprise clients, customers, prospective investors, or entities wishing to access or to initiate a communication with Exchange platform 12 to be delivered via communications network 14. Alternatively, buyer 16 and seller 18 may represent any device or object that seeks to initiate a communication on behalf of another entity or element, such as a program, a database, or any other component, device, element, or object capable of initiating a voice or a data Exchange within system 10. Data, as used herein in this document, refers to any type of numeric, voice, or script data, or any other suitable information in any appropriate format that may be communicated from one point to another. In an example embodiment, buyer 16 and seller 18 are investors interested in purchasing or shorting futures contract 30. Buyer 16 and seller 18 may also be simply seeking to review performance characteristics of futures contract 30 or to ascertain specific details relating to the assets contained therein.

Buyer 16 and seller 18 may each be provided with an end user interface comprising a central processing unit (CPU). The end user interface may be employed by either buyer 16 or seller 18 in order to initiate transactions or to perform swap-monitoring functions within system 10. Alternatively, such an end user interface may be replaced with any other suitable interface or object that facilitates communications between buyer 16, seller 18, and any other element within system 10, such as: a cellular telephone, an electronic notebook, a personal digital assistant (PDA), or any other suitable device (wireless or otherwise), component, or element capable of accessing one or more elements within system 10. The end user interface may also comprise any suitable interface for a human user such as a display, a microphone, a keyboard, or any other appropriate terminal equipment according to particular configurations and arrangements. In addition, the end user interface may be a unique element designed specifically for communications involving the purchase or sale of futures contract 30. Such an element may be fabricated or produced specifically for financial applications involving buyer 16 and seller 18.

Futures module 20 may include processor 24 and memory element 28 in accordance with one example embodiment of the present invention. Futures module 20 may be operable to receive requests from buyer 16 or seller 18 and to process those requests such that financial transactions involving futures contract 30 may be performed. Futures module 20 may have a link or a connection to a futures market trading floor, or some other suitable coupling to any suitable element that allows for such transactions to be consummated. The resultant futures contract 30 that is formulated may be suitably stored in memory element 28 after being properly managed and secured by processor 24. Processor 24 may also assist in processing any financial terms or conditions (e.g. desired interest rate, type of swap, delivery date criteria or other delivery conditions or other parameters described herein, expiration date criteria or other expiration conditions or other parameters described herein, etc.) requested by buyer 16 or seller 18. In cases where futures module 20 is unable to match the requested financial parameters or tendered contract terms provided by buyer 16 or seller 18 with that which is available in the trading market place, futures module 20 may contact buyer 16 or seller 18 and notify either of the circumstances surrounding the inability to fulfill such a request.

It should be noted that the internal structure of futures module 20 is malleable and can be readily changed, modified, rearranged, or reconfigured in order to achieve its intended operations. Accordingly, futures module 20 may be equipped with any suitable component, device, application specific integrated circuit (ASIC), hardware, software, processor, algorithm, read only memory (ROM) element, random access memory (RAM) element, erasable programmable ROM (EPROM), electrically erasable programmable ROM (EEPROM), or any other suitable object that is operable to facilitate the operations of futures module 20. Considerable flexibility is provided by the structure of futures module 20 in the context of system 10. Thus, it can be easily appreciated that futures module 20 could be readily provided external to Exchange platform 12 such that communications involving buyer 16 and seller 18 could still be accommodated and handled properly. In other embodiments, futures module 20 could perform one or more of the tasks provided by price reporting/dissemination element 22 such that accurate pricing information and other relevant data, such as financial data or information related to dates or other parameters relating to delivery and/or expiration, could be adequately communicated to buyer 16 and seller 18.

In an alternative embodiment, communications network 14 and/or futures module 20 may be replaced entirely or partially with a person, providing a human interface to a corresponding futures trading Exchange. In such an embodiment, an agent of Exchange platform 12 or any other suitable person or representative may be contacted by buyer 16 or seller 18 (e.g. via the telephone, a network, other suitable electronic equipment, or directly by word of mouth). The agent or representative may receive a request from buyer 16 or seller 18 to execute some transaction involving futures contract 30. The agent or representative may then proxy or broker the request to an appropriate futures trading floor for execution of the transaction. The agent or representative may then record the transaction once it has been consummated and contact buyer 16 or seller 18 to confirm that the transaction has been executed. A receipt may then be issued to buyer 16 or seller 18 indicating the terms of futures contract 30.

Clearing house 36 may comprise an element that cooperates with Exchange platform 12 in order to ensure a fair and proper execution of transactions and trades initiated by buyer or seller 18. Futures Exchanges may have a clearing association (i.e. similar to Clearing House 36), which operates in conjunction with the futures Exchange in a manner similar to a bank Clearing House. Membership in such a clearing association is generally composed of well-capitalized members of the Exchange and corporations or partnerships, one of whose officials is often an Exchange member. Exchange members who do not join the clearing association can clear their trades through a member of the association. Each member of Clearing House allocates fixed original margins and maintains them with Clearing House 36 in the event of adverse price fluctuations. In such instances, Clearing House 36 may call for additional margins throughout the day without waiting for a routine end-of-day settlement. Clearing House 36 may also apply traditional interest or Price Alignment Interest to such margins.

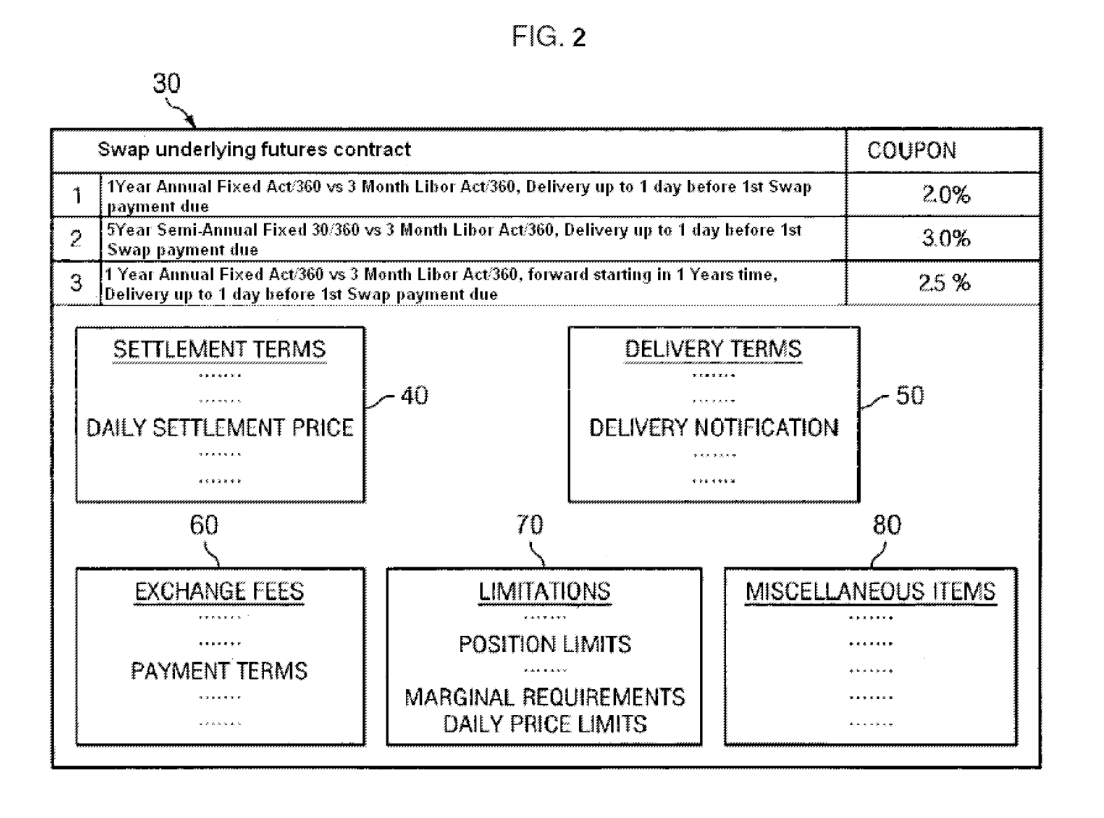

FIG. 2 is a simplified block diagram of three examples of futures contract 30. Futures contract 30 represents the legal instrument that may be used to bind buyer 16 or seller 18 to a stipulated agreement. Futures contract 30 may take any appropriate form such as a written document, an e-mail, a facsimile message, a computer display, an entry in an account, or a verbal agreement between two parties. In some embodiments, some or all of the terms of futures contract 30 may be displayed or otherwise explicit, while other terms may (or may not) be displayed or otherwise explicit. Futures contract 30 provides considerable flexibility in its terms, representations, and stipulations, which in some embodiments may be configured via one or more user interfaces. In general, any information or data that may be germane or of interest to a futures contract Trader or ECP may be included in futures contract 30, provided that the included terms are mutually agreeable to the two (or more) parties bound by futures contract 30.

In one embodiment, used for purposes of teaching and example only, futures contract 30 includes specifications concerning delivery (e.g., of an underlying swap contract) and/or expiration of the futures contract. In some embodiments, futures contract 30 may include specifications comprising a listing of swap data that are to be included in the agreement.

Futures contract 30 may also include a number of additional provisions, stipulations, or conditions, which may include items such as settlement terms 40, delivery terms 50, Exchange fees 60, limitations 70, and miscellaneous items 80 which may include information relating to the delivery of the underlying swap and/or expiration of the futures contract. A myriad of other potential segments may be provided within futures contract 30, as the embodiment of FIG. 2 represents simply one example arrangement of futures contract 30. Such variations may be based on the particular needs of the parties implicated by futures contract 30.

In accordance with the example implementation of FIG. 2, futures contract 30 may represent:
1) A USD denominated contract with an underlying swap of 1 Year tenor, Annual Fixed 2% coupon payments (Actual/360 money market daycount), Quarterly 3 Month Libor floating payments (Actual/360 money market daycount) with a variable delivery date of any day up to 1 day before the 1^{st} (3 Month Libor) payment is due, three months from trade date.
2) A USD denominated contract with an underlying swap of 5 Years tenor, Semi-Annual Fixed 3% coupon payments (30/360 bond basis daycount), Quarterly 3 Month Libor floating payments (Actual/360 money market daycount) with a variable delivery date of any day up to 1 day before the 1^{st} (3 Month Libor) payment is due, three months from trade date.
3) A USD denominated contract with an underlying swap of 1 Year tenor, Annual Fixed 2.5% coupon payments (Actual/360 money market daycount), Quarterly 3 Month Libor floating payments (Actual/360 money market daycount), forward starting in 1 Years time with a variable delivery date of any day up to 1 day before the 1^{st} (3 Month Libor) payment is due, one year and three months from trade date.

Settlement terms 40 may include information relating to contract size (e.g. EUR 1,000,000).

Another term that could be included in settlement terms 40 is any provision relating to the variable delivery date and expiry of the contract terms.

Delivery terms 50 may include information relating to the terms or process associated with delivery associated with futures contract 30. As described herein, the delivery day may be a variable defined by various dates and/or other parameters.

In another example, the third Wednesday (or other day) of a quarterly March, June, September or December delivery month (or other month) may be designated as the last possible delivery day (known in the art as the “IMM Dates”). Delivery notification could also be accounted for, where open short positions would notify the proper entity of the swap instruments they will deliver by the end of trading on their chosen delivery day. The delivery process could also be specified in delivery terms 50. For example, an underlying OTC swap delivered for clearing by LCH Swapclear, Chicago Mercantile Exchange Clearing, InterContinental Exchange Clearing or Eurex Clearing.

Limitations 70 may include information relating to delivery or expiration of the futures contract.

Limitations 70 may alternately or in addition include information relating to items such as margining requirements. For example, an initial margin having a designated amount per contract may be provided. Normal variation margin procedures may be implemented and in accordance with Clearing House 36 procedures and guidelines or special OTC swap type margining procedures may be implemented. Daily price limit guidelines may also be provided for within limitations 70 or designated as infinite in other scenarios. Position limits may also be accounted for in limitations 70.

Miscellaneous items 80 may include any other suitable information chosen or selected by buyer 16, seller 18, or an administrator of Exchange platform 12. For example, trading hours and vacation days could be specified in such a section. Other information provided in miscellaneous items 80 may be offered where appropriate and based on particular needs.

Exemplary Methods

In some embodiments, an apparatus comprising at least one processor and a memory may accomplish the actions in the flow diagrams described herein. The memory may store one or more databases that store instructions that, when executed, direct the processor to perform various actions corresponding to various blocks below.

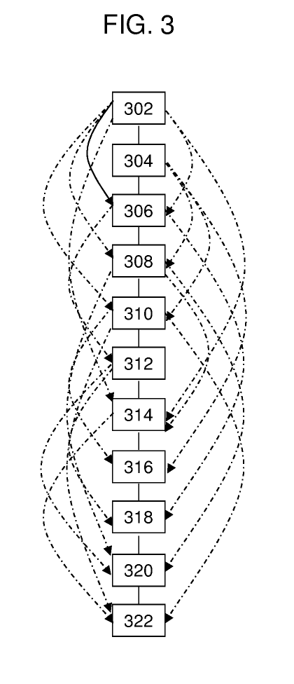

FIG. 3 is a simplified flowchart illustrating a series of example steps associated with one implementation of system 10.

In block 302, the system may receive, trade, and/or store records of one or more trading instruments such as futures contracts.

In block 304, a user may identify one or more parameters relating to a trading product such as a futures contract and/or a swap contract. The parameters may specify any features of a futures contract (and an underlying swap contract), such as notional value, availability for purchase or sale, expiration parameters, quote convention, tick size, settlement information, exchange fees, limitations, and any other features discussed herein. In some embodiments, the parameters may specify dates, conditions, or other parameters or information relating to a delivery time of an underlying swap contract and/or an expiration date of the futures contract. The parameters may be input by a user at a user interface. The parameters may comprise user requirements for a desired purchase or sale of a futures contract (or other trading product) and/or non-essential user preferences for a desired purchase or sale of a futures contract (or other trading product).

In some embodiments, the parameters may be parameters for a search. For example, the user may input search parameters for searching one or more sources (e.g., one or more exchanges) for futures contract(s) (e.g., that are available for purchase or sale) that satisfy (or best satisfy) the user-specified parameters, such as futures contracts with an underlying swap having an delivery date defined by a particular date, range, or other conditions. It should be appreciated that any means of searching may be used, such as the systems and methods used by eBay, google, and other search engines.

In some embodiments, the user may specify one or more parameters of a futures contract (or other trading product) by identifying another futures contract or type, e.g., a futures contract that exists or has existed in at least one market. For example, the user may identify an identification number or code that is unique to that futures contract or futures contract type. The system may identify such futures contract (e.g., based on such code) and determine one or more parameters based at least in part on the identified futures contract.

In some embodiments, a user may configure parameters based on a default set of parameters, e.g., parameters that describe another futures contract (e.g., another futures contract identified by a user). For example, in some embodiments, a user may request a futures contract that is similar in at least one aspect to another one or more futures contracts. The system may auto-populate parameters based on the identified futures contract, and the user may adjust the default parameters to achieve the user's desired parameters.

In block 306, the system may search for one or more trading products such as futures or swap contracts that satisfy, best satisfy, or otherwise correspond to the one or more parameters. For example, the system may search one or more exchanges for futures contracts that satisfy or best satisfy the parameters.

In block 308, the system may define and/or create a futures contract and/or swap contract (or other trading product) that satisfies one or more of the parameters. In some embodiments, the system may determine that no existing futures contract sufficiently satisfy the one or more user-specified parameters. Responsive to this determination, the system may define and/or create one or more futures contracts based on the user-specified parameters (e.g., a futures contract and/or swap contract that satisfies some or all of the user-specified parameters).

In some embodiments, the system may create futures contract eligible to be bought or sold based on one or more other criteria, e.g., one or more conditions that may be met. For example, the system may create a user-requested futures contract and make it eligible for trading after determining that one or more other parties are interested in buying and/or selling such a futures contract. For example, once the system determines that one party is interested in a particular futures contract (or other trading product), the system may query other market participants to determine if one or more other market participants have a firm or non-firm interest in such futures contract or such type of futures contract. Based on determining that interest exists (e.g., interest that exceeds a minimum threshold, such as at least five users have expressed interest in a particular contract or contract type, including at least one user on a purchase side and at least one user on a sell side), the system may make a futures contract eligible for purchase and/or sale.

In block 310, the system may identify one or more futures contracts (or other trading products), e.g., that are found in a search or created in response to the user's parameters, e.g., that best fit the user's parameters. For example, the system may determine that four different futures contracts closely match the user's search parameters, and two futures contracts completely satisfy the parameters.

In block 312, the system may display or otherwise output information about the one or more futures contracts (or other trading products) to the user, e.g., at a user interface. For example, the system may cause the user interface to output a list of futures contracts that satisfy or closely satisfy the parameters. The system may designate which contracts fully satisfy the parameters and which contracts partially satisfy which parameters. The listing may identify one or more relevant parameters of one or more of the listed futures contracts.

In block 314, the user may select a futures contract (or other trading product), e.g., via the user interface. For example, the user may click or highlight the displayed listing of one (or more) of the listed futures contracts. The futures contract may specify one or more terms (such as delivery and/or expiration) relating to the futures contract and/or an underlying swap contract. The futures contract may be an existing futures contract (e.g., already offered for purchase or sale via system) or a newly created contract.

The user may request to purchase or sell the futures contract (or other trading product) or an interest therein. In some embodiments, the user may submit one or more bids or offers on the futures contract. In some embodiments, the user's interest to buy or sell the futures contracts may be disclosed to other users (e.g., via each user's user interface), and those users may submit other bids and offers.

In block 316, the user may purchase (or sell) the futures contract (or an interest therein or other trading product), such as the selected futures contract. For example, in some embodiments the user's bid to purchase or sell the futures contract may be executed, e.g., when the system finds and executes a contra order to sell or purchase the same futures contract. (In this way, the system may remain neutral and avoid holding any position in the futures contract.)

In block 318, the purchase (or sale) may clear in a clearinghouse.

In block 320, the user may sell to (or purchase from) all or part of the futures contract or interest therein (or other trading product), e.g., to a second user.

In block 318, the purchasing party may sell all or a part of its interest to another party, such as the first user or a third user.

In block 320, a condition or parameter relating to the trading product, such as an expiration of the futures contract, may occur. The system may detect such condition(s).

In block 318, the futures contract may expire in response to the condition or parameter (or other condition triggered event may occur with respect to another trading product). For example, the futures contract may expire on a deadline date specified in the futures contract.

In block 320, a condition or parameter relating to the delivery of the underlying swap contract may occur. For example, a holder of the relevant futures contract or another party such as the Clearing House may request delivery during a delivery date range, e.g., pursuant to terms of the futures contract.

In block 322, delivery of the swap contract may be triggered as a result of the condition or parameter. The swap contract may be delivered accordingly.

### Additional Exemplary Embodiments

Additional non-limiting exemplary embodiments include the following exemplary apparatus, methods, and machine-readable media.

A. A method comprising:

causing, by at least one processor, a futures contract to be traded, said futures contract including terms that facilitate delivery of a specified swap to a Clearing House according to a delivery time specified in the futures contract, the delivery time consisting of one of:

a date on or within a specified date range, and

a date prior to a specified deadline date.

B. The method of embodiment A, in which the delivery time comprises a date on or within a date range specified in the futures contract.

C. The method of embodiment A, in which the delivery time comprises a date prior to a deadline date specified in the futures contract.

D. The method of any of embodiments A and B, in which the specified swap contract is delivered on a day determined after settlement of the futures contract.

E. The method of any of embodiments A, B, and D, in which the specified swap contract is delivered on a day determined by a purchaser of the futures contract.

F. The method of any of embodiments A, B, and D, in which the specified swap contract is delivered on a day determined by a party other than a holder of the futures contract.

G. The method of any of embodiments A, B, and D, in which the specified swap contract is delivered on a day determined by a Clearing House according to an algorithm provided by an Exchange.

H. The method of any of embodiments A, B, D, F, and G, in which the futures contract expires on an expiration date that is on or within a date range specified in the futures contract.

I. The method of any of embodiments A, B, D, F, and G, in which the futures contract expires on an expiration date that is prior to a deadline date specified in the futures contract.

J. The method of any of embodiments A, B, D, F, G, I, and J, in which the futures contract expires on a day determined after settlement of the futures contract.

K. The method of any of embodiments A-J, in which the futures contract expires on a day selected by a purchaser of the futures contract.

L. The method of any of embodiments A, B, D, F, G, I, J, and K, in which the futures contract expires on a day selected by a purchaser of the futures contract.

M. The method of any of embodiments A, B, D, F, G, I, J, and K, in which the futures contract expires on a day selected by a party other than a holder of the futures contract.

N. The method of any of embodiments A-L, in which the terms included in the futures contract specify that the futures contract will expire upon the occurrence of zero open interest.

O. The method of any of embodiments A-J, in which the futures contract expires upon the occurrence of zero open interest.

P. The method of any of embodiments A-J, further comprising:

determining, by the at least one processor, an occurrence of zero open interest with respect to the futures contract; and

based on the act of determining an occurrence of zero open interest with respect to the futures contract, causing the futures contract to expire.

Q. The method of any of embodiments A-J, further comprising:

determining, by the at least one processor, an occurrence of zero open interest with respect to the futures contract; and

based on the act of determining an occurrence of zero open interest with respect to the futures contract, causing the futures contract to be delisted.

R. The method of any of embodiments A-J, in which the terms included in the futures contract specify that the futures contract will expire upon the occurrence of zero open interest.

S. The method of any of embodiments A-J, in which the futures contract is delisted upon the occurrence of zero open interest.

T. The method of embodiment A, in which the futures contract specifies a variable expiry upon delivery the specified futures contract, and wherein the variable contract expiry upon delivery of the specified swap contract prompts de-listing of said futures contract.

U. The method of embodiment A, in which the specified swap is a yield curve swap.

V. The method of embodiment A, in which the specified swap is a credit default swap.

W. The method of embodiment A, in which the specified swap is a credit default index swap.

X. The method of embodiment A, in which the specified swap is a cross currency swap.

Y. The method of embodiment A, in which the specified swap is a constant maturity swap.

Z. The method of embodiment A, in which the specified swap is a variance swap.

AA. The method of embodiment A, in which the specified swap is a volatility swap.

BB. The method of embodiment A, in which the specified swap is a basis swap.

CC. The method of embodiment A, in which the specified swap is an asset swap.

DD. The method of embodiment A, in which the specified swap is a commodity swap.

EE. The method of embodiment A, in which the specified swap is an equity swap.

FF. The method of embodiment A, in which the specified swap is a dividend swap.

GG. The method of embodiment A, in which the specified swap is a Cross Currency swap.

HH. The method of embodiment A, in which the specified swap is a Fixed/Floating interest rate swap.

II. The method of embodiment A, in which the specified swap is a floating basis swap.

JJ. A method comprising:

trading, via at least one processor, a futures contract, said futures contract including terms that facilitate delivery of a specified swap to a Clearing House according to a delivery time consisting of one of:
a date on or within a specified date range, and
a date prior to a specified deadline date,
wherein said futures contract expires upon the occurrence of zero open interest.

KK. A method comprising:

listing via a computer a futures contract, said futures contract including terms that facilitate variable contract expiry upon delivery of a specified swap to a Clearing House according to a delivery time consisting of one:
a date on or within a specified date range, and
a date prior to a specified deadline date;

wherein said futures contract is delisted upon an occurrence of zero open interest.

LL. A method comprising:

receiving from a Trader, by at least one processor, a request for a futures contract to be listed on an Exchange;

responsive to the request, causing, by at least one processor, a futures contract to be listed on the Exchange, said futures contract including terms that facilitate delivery of a swap to a Clearing House according to a delivery time specified in the futures contract, the delivery time consisting of one of:
a date on or within a specified date range, and
a date prior to a specified deadline date.

MM. The method of embodiment 38, further comprising:

in which the act of receiving the request from the Trader comprises receiving date criteria, in which the delivery time satisfies the date criteria.

NN. A method comprising:

receiving from a user, by at least one processor, one or more specifications relating to a futures contract;

responsive to receiving the one or more specifications, outputting a listing of at least one futures contract that satisfies the one or more specifications;

receiving from a user, by at least one processor, a request to purchase or sell a first of the at least one futures contract that satisfies the one or more specifications, the first futures contract including terms that facilitate delivery of a specified swap to a Clearing House according to a delivery time specified in the first futures contract, the delivery time consisting of one of:
a date on or within a specified date range, and
a date prior to a specified deadline date.

OO. The method of embodiment NN, in which the one or more specifications received from the user comprise criteria defining at least one of an end date and a plurality of dates, in which the delivery time specified in the first futures contract satisfies the at least one of an end date and a plurality of dates.

PP. The method of embodiment NN, in which the one or more specifications received from the user comprise the delivery time consisting of one of (1) a date on or within a date range and (2) a date prior to a deadline date.

QQ. The method of embodiment NN, further comprising:

before receiving the one or more specifications, causing, by the at least one processor, a plurality of selectable parameters relating to a futures contract to be displayed in each of a plurality of fields at a user interface,

in which the act of receiving from the user the one or more specifications comprises receiving from the user, via the user interface, a selection of a selectable parameter in each of the plurality of fields.

RR. The method of embodiment QQ, in which the act of receiving a selection of a selectable parameter in each of the plurality of fields comprises receiving from the user a selection of at least one settlement term in at least one field relating to a settlement term.

SS. The method of embodiment QQ, in which the act of receiving a selection of a selectable parameter in each of the plurality of fields comprises receiving from the user a selection of at least one exchange fee parameter in at least one field relating to an exchange fee.

TT. The method of embodiment QQ, in which the act of receiving a selection of a selectable parameter in each of the plurality of fields comprises receiving from the user a selection of at least one coupon parameter in at least one field relating to a coupon.

UU. The method of embodiment QQ, in which the act of receiving a selection of a selectable parameter in each of the plurality of fields comprises receiving from the user a selection of at least one parameter defining an underlying swap in at least one field relating to an underlying swap.

VV. The method of embodiment QQ, in which the act of receiving a selection of a selectable parameter in each of the plurality of fields comprises receiving from the user a selection of at least one delivery term parameter in at least one field relating to a delivery term.

WW. The method of embodiment QQ, in which the act of receiving a selection of a selectable parameter in each of the plurality of fields comprises receiving from the user a selection of at least one limitation parameter in at least one field relating to a limitation.

XX. The method of embodiment QQ, in which the one or more specifications indicate at least one of an intent to purchase a futures contract that satisfies the one or more specifications and an intent to sell a futures contract that satisfies the one or more specifications.

YY. The method of embodiment NN, further comprising:

before outputting the listing, and responsive to receiving the one or more specifications, determining whether a futures contract available on at least one Exchange satisfies the one or more specifications.

ZZ. The method of embodiment YY,

in which the act of determining whether a futures contract available on at least one Exchange satisfies the one or more specifications comprises determining that at least one futures contract available on at least one Exchange satisfies the one or more specifications, and

in which the act of outputting a listing of at least one futures contract that satisfies the one or more specifications comprises outputting a listing comprising the at least one futures contract available on the at least one Exchange that satisfies the one or more specifications.

AAA. The method of embodiment YY,

in which the act of determining whether a futures contract available on at least one Exchange satisfies the one or more specifications comprises determining that there are no futures contracts satisfying the one or more specifications that are available on the at least one Exchange, further comprising:

causing, by the at least one processor, at least a first futures contract that satisfies the one or more specifications to be created, in which the act of outputting the listing comprises displaying the first futures contract at a user interface.

BBB. An apparatus comprising:

at least one processor; and

at least one memory having instructions stored thereon which, when executed by the at least one processor, direct the at least one processor to perform the method of any of embodiments A-AAA.

CCC. A tangible machine-readable medium having instructions stored thereon which, when executed by at least one processor, direct the at least one processor to perform the method of any of embodiments A-AAA.

### XII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the disclosed methods and method steps without departing from the scope of the invention. The methods may include more, fewer, or other steps. Additionally, steps may be performed in any suitable order without departing from the scope of the invention.

While this disclosure has been described in terms of certain embodiments and generally associated methods, alterations and permutations of the various systems, methods, software, and other embodiments will be apparent to those skilled in the art. Accordingly, the above description of example embodiments does not constrain this disclosure. Other changes, substitutions, and alterations are also possible without departing from the spirit and scope of this disclosure, e.g., as defined by the claims herein.

In particular, it should be appreciated that while this disclosure has generally been described in reference to futures contracts and underlying swap contracts, the features and embodiments described herein may also apply to other financial instruments or other trading products, such as stocks, bonds, calls, puts, warrants, swaps, and other trading products.

### XIII References

It should be appreciated that various embodiments of the present invention may use one or more features, technologies, matching systems, execution systems, clearing systems, user configuration systems, brokering systems, and other features of any of the features disclosed in the following documents: U.S. Ser. No. 10/689,185, filed Oct. 20, 2003, entitled “System and Method for Providing Futures Contracts in a Financial Market Environment,” and U.S. Ser. No. 13/453,548, filed Apr. 23, 2012, entitled “System and Method for Providing Futures Contracts in a Financial Market Environment,” the disclosures of which are hereby incorporated by reference herein in their entireties.

1. A method comprising:
causing, by at least one processor, a futures contract to be traded, said futures contract including terms that facilitate delivery of a specified swap to a Clearing House according to a delivery time specified in the futures contract, the delivery time comprising one of:
a date on or within a specified date range, and
a date prior to a specified deadline date.

2. The method of claim 1, in which the delivery time comprises a date on or within a date range specified in the futures contract.

3. The method of claim 1, in which the delivery time comprises a plurality of dates prior to a deadline date specified in the futures contract.

4. The method of claim 1, in which the specified swap contract is delivered on a day determined after settlement of the futures contract.

5. The method of claim 1, in which the specified swap contract is delivered on a day determined by a purchaser of the futures contract.

6. The method of claim 1, in which the specified swap contract is delivered on a day determined by a party other than a holder of the futures contract.

7. The method of claim 1, in which the specified swap contract is delivered on a day determined by a Clearing House according to an algorithm provided by an Exchange.

8. The method of claim 1, in which the futures contract expires on an expiration date that is on or within a date range specified in the futures contract.

9. The method of claim 1, in which the futures contract expires on an expiration date that is prior to a deadline date specified in the futures contract.

10. The method of claim 1, in which the futures contract expires on a day determined after settlement of the futures contract.

11. The method of claim 1, in which the futures contract expires on a day selected by a purchaser of the futures contract.

12-13. (canceled)

14. The method of claim 1, further comprising:
determining, by the at least one processor, an occurrence of zero open interest with respect to the futures contract; and
based on the act of determining an occurrence of zero open interest with respect to the futures contract, performing one of:
causing the futures contract to expire; and
causing the futures contract to be delisted.

15-20. (canceled)

21. The method of claim 1, in which the specified swap is one of a yield curve swap, a credit default swap, a credit default index swap, a cross currency swap, a constant maturity swap, a variance swap, a volatility swap, a basis swap, an asset swap, a commodity swap, an equity swap, a dividend swap, a Fixed/Floating interest rate swap, and a floating basis swap.

22-39. (canceled)

40. A method comprising:
receiving from a user, by at least one processor, one or more specifications relating to a futures contract;
responsive to receiving the one or more specifications, causing to be output, by the at least one processor, a listing of at least one futures contract that satisfies the one or more specifications;
receiving from a user, by the at least one processor, a request to purchase or sell a first of the at least one futures contract that satisfies the one or more specifications, the first futures contract including terms that facilitate delivery of a specified swap to a Clearing House according to a delivery time specified in the first futures contract, the delivery time comprising one of:
a date on or within a specified date range, and
a date prior to a specified deadline date.

41. (canceled)

42. The method of claim 40, in which the one or more specifications received from the user comprise the delivery time consisting of one of (1) a date on or within a date range and (2) a date prior to a deadline date, further comprising:
before receiving the one or more specifications, causing, by the at least one processor, a plurality of selectable parameters relating to a futures contract to be displayed in each of a plurality of fields at a user interface,
in which the act of receiving from the user the one or more specifications comprises receiving from the user, via the user interface, a selection of a selectable parameter in each of the plurality of fields, and
in which the one or more specifications indicate at least one of an intent to purchase a futures contract that satisfies the one or more specifications and an intent to sell a futures contract that satisfies the one or more specifications.

43. (canceled)

44. The method of claim 43, in which the act of receiving a selection of a selectable parameter in each of the plurality of fields comprises receiving from the user a selection of at least one of: at least one settlement term in at least one field relating to a settlement term, at least one exchange fee parameter in at least one field relating to an exchange fee, at least one coupon parameter in at least one field relating to a coupon, at least one parameter defining an underlying swap in at least one field relating to an underlying swap, at least one delivery term parameter in at least one field relating to a delivery term, and at least one limitation parameter in at least one field relating to a limitation.

45-51. (canceled)

52. The method of claim 51, further comprising:
before causing the listing to be output, and responsive to receiving the one or more specifications, determining whether a futures contract available on at least one Exchange satisfies the one or more specifications,
in which the act of determining whether a futures contract available on at least one Exchange satisfies the one or more specifications comprises determining that at least one futures contract available on at least one Exchange satisfies the one or more specifications, and
in which the act of causing to be output a listing of at least one futures contract that satisfies the one or more specifications comprises outputting a listing comprising the at least one futures contract available on the at least one Exchange that satisfies the one or more specifications.

53. The method of claim 51, further comprising:
before causing the listing to be output, and responsive to receiving the one or more specifications, determining whether a futures contract available on at least one Exchange satisfies the one or more specifications,
in which the act of determining whether a futures contract available on at least one Exchange satisfies the one or more specifications comprises determining that there are no futures contracts satisfying the one or more specifications that are available on the at least one Exchange, further comprising:
causing, by the at least one processor, at least a first futures contract that satisfies the one or more specifications to be created, in which the act of causing the listing to be output comprises displaying the first futures contract at a user interface.

54-55. (canceled)

56. The method of claim 1, further comprising:
prior to causing the futures contract to be traded, receiving from a trader, by at least one processor, a request for a futures contract to be listed on an exchange, in which the act of receiving the request from the trader comprises receiving date criteria, in which the delivery time satisfies the date criteria.

57. A non-transitory machine-readable storage medium having instructions stored thereon that are configured to cause a processor to:
cause a futures contract to be traded, said futures contract including terms that facilitate delivery of a specified swap to a Clearing House according to a delivery time specified in the futures contract, the delivery time comprising one of:
a date on or within a specified date range, and
a date prior to a specified deadline date.
